(19) United States
(12) Patent Application Publication
(10) Pub. No.: US 2012/0329016 A1
(43) Pub. Date: Dec. 27, 2012

(54) METHOD FOR DELIVERING ONLINE CONTENT TO A TARGET GROUP

(76) Inventors: Gaurav Kapoor, Bangalore (IN); Tarun Mathur, Bell Canyon, CA (US)

(21) Appl. No.: 13/574,653

(22) PCT Filed: Feb. 4, 2011
(86) PCT No.: PCT/IB11/50496

§ 371 Date: Jul. 23, 2012

(30) Foreign Application Priority Data
Feb. 6, 2010 (IN) 304/CHE/2010

(51) Int. Cl. G09B 19/00

(52) U.S. Cl. 434/219

(57) ABSTRACT

A method for delivering online content to a target group is disclosed. The target group in the exemplary embodiment comprises health care professionals. The method comprises providing two or more learning groups, where each learning group is associated with corresponding learning objectives for the target group. The method further includes profiling the health care professionals based on different attributes to provide a professional profile for each health care professional. Further, a mapping is done for the health care professionals with the two or more learning groups based on the professional profile. Adaptive content is then selected from a library based on the professional profile and the adaptive content that is personalized based on professional profile is delivered to the health care professionals.

### TECHNICAL FIELD

The invention relates generally to a method for delivering content to a health care professional, and more specifically to a method for delivering adaptive content.

### BACKGROUND

In the field of marketing and also in education, there are different techniques that are employed to deliver the message or content to the target group. Currently these techniques broadly design and deliver the content based on the experience, practice and knowledge of the individuals in the target group.

Typically, most of the techniques available today follow two formats for providing the content. One is a static format, where an assumption is made regarding the average experience, practice, knowledge of the target individuals and the same content is delivered to all of them. The content remains largely static and is repeated to the next set of target audience in the same category. Most educational institutions follow this format.

The second format for providing the content is being done in the digital environment. Recently, with the advent of internet and related communication and software technologies, effort has been made to customize the content as per user requirements. This is currently being mostly done with respect to advertising and marketing of campaigns. There are some specific techniques that monitor user behavior on purchasing sites like Amazon™ or Ebay™ or credit card websites that track purchase pattern or the pattern of sites most visited and then send advertisements for related goods and services to the user. Such a manner of providing content is useful for a professional in a field, as well as a general internet surfer.

However, these techniques fall short of requirements in certain specific fields for a variety of reasons including the fact that new technologies and products are being made at a faster pace and the professionals engaged in such fields have time constraints to absorb new information and therefore do not respond to the above techniques of engagement. In health care for example, it will be of no use to provide information about a drug that the doctor is already prescribing. Therefore, medical or sales representatives are usually used to advertise and educate the doctors about any new medicine or diagnostic devices, and there is a burden on the medical representative to be apprised of the doctor's prescription preferences. Further, despite being forearmed with a doctor's preferences, the access time the medical representatives may get from the doctor is very less and the success rate for this type of advertising is going down. It has been recorded that only 8% of sales representatives make impact calls across physician clinics and only 7% of the visits with a physician last longer than two minutes.

Accordingly there is a need to provide an effective solution to engage with the health care professionals and provide relevant content.

### BRIEF DESCRIPTION

In one aspect, the invention provides a method for delivering online content to a target group. The target group in the exemplary embodiment comprises health care professionals. The method comprises providing two or more learning groups, where each learning group is associated with corresponding learning objectives for the target group. The method further includes profiling the health care professionals based on different attributes to provide a professional profile for each health care professional. Further, a mapping is done for the health care professionals with the two or more learning groups based on the professional profile. Adaptive content is then selected from a library based on the professional profile and the adaptive content that is personalized based on professional profile is delivered to the health care professionals.

### DRAWINGS

These and other features, aspects, and advantages of the present invention will become better understood when the following detailed description is read with reference to the accompanying drawings in which like characters represent like parts throughout the drawings, wherein:

FIG. 1 is a flowchart representation of a method for delivering online content to a target group of health care professionals; and

FIG. 2. is a flowchart representation of the method of FIG. 1 pertaining to delivering adaptive content to the health care professionals based on dynamic profiles.

### DETAILED DESCRIPTION

As used herein and in the claims, the singular forms “a,” “an,” and “the” include the plural reference unless the context clearly indicates otherwise.

Online content as used herein refers to any content that is available through internet. The online content, while being made available through the internet, may also be accessed while still online, or in an offline mode as well. Methods of making online content offline are known to one of ordinary skill in the art.

Library as used herein refers to a collection of sources, resources, and services, that may be organized for easy retrieval, and includes a digital library.

Content as used herein refers to any information and experiences that may provide value for a target group. Content may be in different formats including encoded formats.

Adaptive content as used herein means content that is tailored, renewed or changed on periodic basis.

Target group as used herein refers to a primary group of individuals for which the content needs to be tailored. The target group can be based on for example, a skill, educational qualification, age group, gender, profession and different combinations of these.

Health care professionals as used herein refer to a qualified person who provide health care services professionally to any individual in need of health care services. These include, doctors, general practitioners, operating department practitioners, nurses, physicians, physician assistants, physiotherapist, health care providers, pharmacists, dietitians, therapists, paramedics, and a wide variety of other individuals that provide some type of health care.

Learning group as referred herein means a sub group within the target group that has similar education or learning objectives or has predefined and desired skill levels.

Learning objectives as referred herein means educational or skill related goals that are predefined for each learning group.

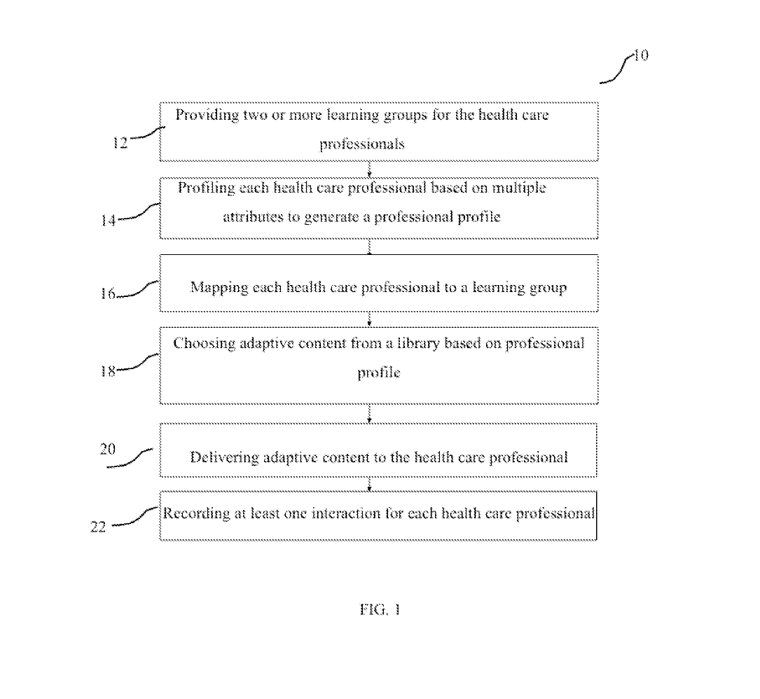

Now turning to drawings, FIG. 1 is a flowchart representation 10 for a method for delivering online content to a target group. The target group includes one or more health care professionals, in the exemplary embodiment. However it would be understood by those skilled in the art that the target group could include professionals for any particular skill, or even students for any learning discipline.

The method includes at step 12, providing two or more learning groups, where each learning group is associated with corresponding learning objectives for the target group. The learning groups could be of any number for example 2, 3, 4, 5, 6, or more, based on the skill or learning discipline for the target group and the general skill levels of individuals in that learning discipline. Different analytical studies and approaches may be used to ascertain the number of learning groups. The learning objectives are set for each learning group based on the certain standards and/or any external compliance requirements in the health care domain. These compliance requirements may be typically set by jurisdiction specific administrative bodies, such as AMA (American Medical Association), FDA (Food and Drug Administration) in US, or worldwide administrative authorities such as WHO (World Health Organization).

The method further includes at step 14, profiling the one or more health care professionals based on different attributes to provide a professional profile for each health care professional. In the exemplary embodiment the different attributes include personal details, learning preferences, practice details, measured attributes, and one or more tracking attributes for each health care professional. The personal details as mentioned herein may include for example, name, address, phone, years in practice, and other personal details. Learning preferences may include details related to preferred format of learning, preferred method of communication etc. The practice details may include data such as specialty, disease area, typical patient profile type, and the like.

The measured attributes as mentioned herein include measurement data received through an interaction with the health care professional related to diagnosis, treatment, and management of various disease states, specialties and therapy areas. The measured attributes are related to diagnostic aspects such as differential diagnosis, lab tests, final diagnosis, treatment, management of disease, patient etc. Some measured attributes are reasons related to brand preferences by a health care professional, some exemplary reasons include safety, efficacy, cost, tolerability etc. Some other measured attributes are related to molecule preferences such as safety, efficacy, cost, tolerability etc. Molecules, as used herein may refer to a pharmaceutical actives (also known as actives), a pharmaceutical formulations, actives are made available in various forms such as injectables, inhalants, lozenges, chewable tablets, suspensions, and the like.

The tracking attributes include formats of content viewed, time spent, ratings on content by the healthcare professional, engagement type for the health care professional. The engagement type for example, could be one of mentorship, community leader type of engagement or learner, community participant type of engagement. In operation, the tracking attributes will also include the response by the health care professional to any questionnaire that is a part of adaptive content delivered to the health care professional, the correct response, any weights based on points achieved based on correct answers, and completion status if desired.

One skilled in the art would appreciate that the professional profile may be arrived by assigning a variety of weights and measures to each of the attributes, and subsequently, stitching together the profile for each health care professional accordingly. The representation of the professional profile may be done in a variety of different ways, such as a pictorial representation, a textual representation, a graphical representation, and so on, and combinations thereof as well.

It may also be noted that the professional profile also comprises strength areas, and/or development needs for each health care professional based on the different attributes, the target group and the associated learning objectives.

The method further comprises at step 16 mapping the one or more health care professionals with the two or more learning groups based on the professional profile. The mapping comprises an underlying analysis of the professional profiles of the health care professionals with respect to the learning objectives of the different learning groups and appropriately bucketing or categorizing the health care professionals in the appropriate learning group.

The method further comprises at step 18 choosing an adaptive content from a library based on the professional profile, and at step 20 delivering the adaptive content to the one or more health care professional. The content may include medical case simulation videos, technical papers and publications, webcasts, brand communications etc. It would be appreciated by one skilled in the art that the selection of the adaptive content is based on development needs for each health care professional. Further the delivery of the content could be though a variety of communication modes for example but not limited to electronic mail, short messaging services, phone calls, online banner advertisements, a dedicated tool and user interface, direct mailer, in-person contact, and any another means of communication preferred by the health care professional.

The adaptive content has an associated metadata to describe and identify the content type. The associated metadata includes technical parameters, for example, format type, size, expected duration, device requirements, Digital Rights Management (DRM) attributes; and target group parameters, like specialty, disease area, etc, content type for example but not limited to educational or promotional content. The associated metadata also includes the educational relevance or message relevance parameters for the adaptive content with respect to diagnostic attributes like the differential diagnosis, final diagnosis, treatment, disease or patient management; brand attributes related to safety, efficacy, cost, tolerability etc, and molecule preference based on safety, efficacy, cost, tolerability etc. It is worth noting that the educational relevance parameters for the adaptive content may match the measured attributes associated with the professional profiles of the health care professionals.

The method further comprises at step 22 recording at least one interaction for each health care professional. The interaction as used herein implies the action of reading, providing feedback, forwarding, sending a reply or a query, deleting, rating, answering, and similar such action by the health care professional on receipt of the adaptive content. The recording step includes recording of different aspects related to the associated metadata of the adaptive content.

In one embodiment, the at least one interaction comprises collaborating between the one or more health care professionals. In a specific embodiment, collaborating comprises mentoring by the one or more health care professional. In another embodiment, collaborating comprises discussion among a group of health care professionals. In yet another embodiment, collaborating comprises solving one or more problems as a group by a group of health care professionals. The one or more problems may be a real problem faced by the one or more health care professional, or may be a simulated situation provided to the group.

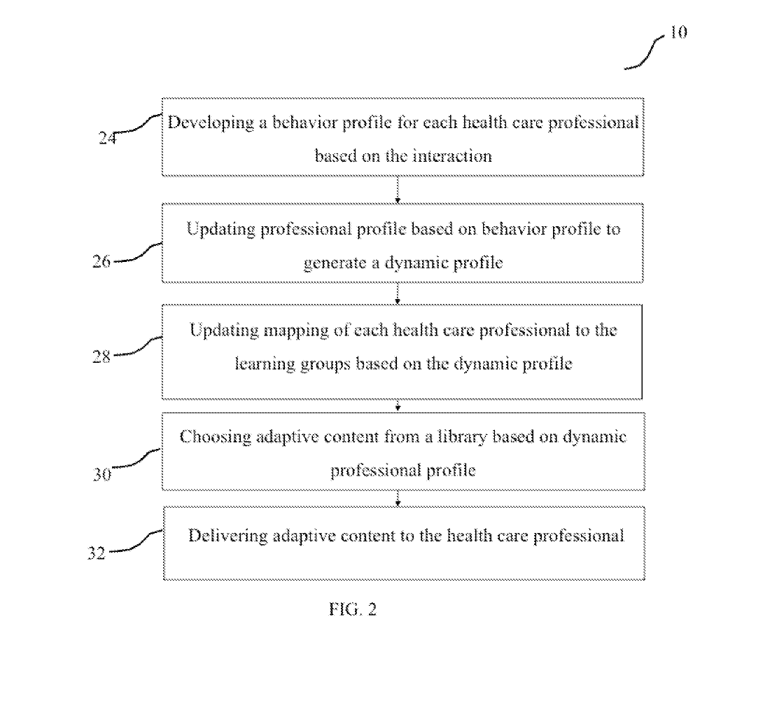

FIG. 2 is a flowchart representation of subsequent steps of method 10. The method further comprises at step 24 developing a behavior profile for each health care professional based on the at least one interaction. Thus the response of the health care professional leads to determination of different behavior attributes for each health care professional that are indicators of their preferences, strength areas and development needs, and the learning behavior attributes. Based on the behavior profile the professional profile of the health care professional gets updated to generate a dynamic professional profile as indicated at step 26. It may be appreciated by those skilled in the art, that since every interaction provides inputs for behavior profile, the behavior profile gets continuously updated and consequently the professional profile gets continuously updated to provide a dynamic professional profile at any given instance of time. As noted herein above, one of the interactions is a collaborating interaction between the health care professionals. The behavior profile provides indicators towards health care professionals who could be mentors to others or who have relevant information that will help the other health care professionals. The relevant information may pertain to a disease, therapy, organ, a health care issue, a medication, a brand, a molecule and any other relevant information for another health care professional. The behavior profile will also monitor progress of a health care professional with respect to the development needs.

The dynamic professional profile thus obtained is further used for updating the mapping of each health care professional in the two or more logical groups as indicated at step 28. Thus the grouping of each health care professional in each of the logical groups is regularly monitored and updated based on the dynamic professional profile.

The method further comprises defining adaptive rules to map the adaptive content to the dynamic professional profile, as indicated at step 30 so that the health care professional receives adaptive content that is relevant to his or her current requirements and preferences as indicated at step 32. The adaptive rules are used to determine the development needs by executing a gap analysis with respect to the learning objectives using the dynamic profile of the health care professional. The adaptive rules also search the library to find content containing metadata that would address the development needs of the health care professional.

In one example the adaptive content is a campaign management content, for example a pharmaceutical communication program, and may have, for example, the following structure and associate rules: a campaign overview including campaign title, owner, start date, target group (for example, doctor, nurse, office staff, etc.), learning group (can be multiple), geographies, therapeutic area/Specialty/disease state profiles.

It may also include campaign details including rules that may be set at an aggregate level and do not depend on the number of interactions. Exemplary rules may include “Invite success rate” i.e. the number of times that health care professional responded to an invitation sent through a system that implements the method of the invention, and “Average time spent” for each health care professional interacting with content on the system.

Campaign details may include ‘Click’ events (can be multiple for a campaign), and may be referred to as ‘Interaction’ events to record the interactions. The Click events may include ‘Invite’ messages (can be multiple for a campaign) having the following parameters: Channel (SMS, email, call center), text for subject line, text for message body, and content parameters. The content parameter may be a specific content identifier or it may be a parameter that the system will use to select content. Content parameters may include multiple content entries that can be associated with an invite so long as each entry is of a different content format type. When the system sends the invite, it will send the content that most closely matches the format preferred by the health care professional. Click events will also indicate the wait time after completing the previous interaction before starting this one. Further the click event will also record the number of days of wait period after sending the invite to receive a response from the health care professional. If the health care professional does not engage with the content within this period of time, the system will send the next invite in the “Invite” queue.

Thus the method advantageously provides a real-time adaptive content to the health care professionals to improve the health care professionals' compliance with the learning objectives rather than simply complimenting the health care professionals' existing knowledge base. For implementation of the method, a tool and system that uses the method steps of the invention are provided that would engage the health care professionals in a constructive and contributory manner to help them increase their current knowledge base to comply with the set standards, so that each health care professional is equipped with the relevant knowledge necessary in the field of their practice. The method of the invention is useful for ensuring the health care professional remains compliant to certain requirements and standards. The method is also useful in sharing knowledge between professionals and spreading best practice information quickly and efficiently. Further, the method facilitates providing specific and relevant advertising campaigns for a given health care professional by product companies, such as drug discovery companies.

Though the methods and tool described herein are in reference with a healthcare professional, however the exemplary method and tool is similarly applicable to other learning fields and for different individuals in a defined target groups including students, professionals, where the method and system interactively engages with the individuals in the target group, assesses their current positioning (or level) in reference to the learning objectives, provide relevant content to enhance their learning, and facilitates them to reach the desired position in the learning field. Thus aspects of the disclosed method and tool also include a method for providing content and influencing desired behavior of an individual or a group.

It may be appreciated by one skilled in the art that the method and process steps and algorithms described herein can be executed by means of software running on a suitable processor, or by any suitable combination of hardware and software. When software is used, the software can be accessed by a processor using any suitable reader device which can read the medium on which the software is stored. The computer readable storage medium can include, for example, magnetic storage media such as magnetic disc or magnetic tape; optical storage media such as optical disc, optical tape, or machine readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application. Similarly a communication link that may be an ordinary link or a dedicated communication link may be provided for accessing the tool as described herein from a user's work station.

While only certain features of the invention have been illustrated and described herein, many modifications and changes will occur to those skilled in the art. It is, therefore, to be understood that the appended claims are intended to cover all such modifications and changes as fall within the true spirit of the invention.

I/We claim:

1. A method for delivering online content to a target group, wherein the target group comprises one or more health care professionals, the method comprising:
providing two or more learning groups, wherein each learning group is associated with corresponding learning objectives for the target group;
profiling the one or more health care professionals based on a plurality of attributes to provide a professional profile for each health care professional;
mapping the one or more health care professionals with the two or more learning groups based on the professional profile;
choosing an adaptive content based on the professional profile, from a library; and
delivering the adaptive content to the one or more health care professional.

2. The method of claim 1 wherein the professional profile comprises strength areas.

3. The method of claim 1 wherein the professional profile comprises development needs.

4. The method of claim 3 wherein the choosing of the adaptive content is based on development needs.

5. The method of claim 1 wherein the adaptive content comprises associated metadata based on the plurality of attributes, wherein the associated metadata includes a technical parameter, a target group parameter, and an educational relevance parameter.

6. The method of claim 1 wherein the plurality of attributes comprises one or more personal details, learning preferences, practice details, measured attributes, and one or more tracking attributes.

7. The method of claim 1 further comprising recording at least one interaction for each health care professional.

8. The method of claim 7 further comprising developing a behavior profile for each health care professional based on the at least one interaction.

9. The method of claim 8 further comprising:
updating the professional profile based on the behavior profile of each health care professional to give an dynamic professional profile; and
updating the mapping of each health care professional in the two or more logical groups based on the dynamic professional profile.

10. The method of claim 9 further comprising defining adaptive rules to map the adaptive content to the dynamic professional profile.

11. The method of claim 8 wherein developing the behavior profile comprises capturing learning behavior attributes.

12. The method of claim 7 wherein the at least one interaction comprises collaborating between the one or more health care professionals.

13. The method of claim 12 wherein collaborating comprises mentoring by the one or more health care professional.

14. A tool that uses the method of claim 1.

15. A system that comprises the tool of claim 14.

16. A computer program product comprising: a computer useable medium having a computer readable code including instructions for:
providing two or more learning groups, wherein each learning group is associated with corresponding learning objectives for the target group;
profiling the one or more health care professionals based on a plurality of attributes to provide a professional profile for each health care professional;
mapping the one or more health care professionals with the two or more learning groups based on the professional profile;
choosing an adaptive content based on the professional profile, from a library; and
delivering the adaptive content to the one or more health care professional.

17. The computer program product of claim 16, wherein the computer readable code includes further instructions for:
updating the professional profile based on the behavior profile of each health care professional to give an dynamic professional profile; and
updating the mapping of each health care professional in the two or more logical groups based on the dynamic professional profile.

18. The computer program product of claim 17, wherein the computer readable code includes further instructions for: defining adaptive rules to map the adaptive content to the dynamic professional profile.
